(19) United States
(12) Patent Application Publication
(10) Pub. No.: US 2011/0297702 A1
(43) Pub. Date: Dec. 8, 2011

(54) DISPENSING CONTAINER WITH BOTTOM VALVE

(75) Inventors: Don Hildebrandt, Thorntown, IN (US); Shane Smith, Plainfield, IN (US); Anthony Sansone, Greenwood, IN (US)

(73) Assignee: Stephen Gould Corporation, Whippany, NJ (US)

(21) Appl. No.: 12/898,244

(22) Filed: Oct. 5, 2010

Related U.S. Application Data
(63) Continuation-in-part of application No. 29/363,041, filed on Jun. 3, 2010.

(51) Int. Cl. B67D 7/06; B65D 47/00; B65D 5/72; B65D 88/26

(52) U.S. Cl. 222/185.1; 222/460; 222/561; 229/122.2

(57) ABSTRACT

A disposable corrugated board dispensing container including an enclosure having a bottom wall and side walls including a front side wall for containing contents therein. The bottom wall is formed by overlapping flaps attached to each of the side walls at a fold line, and an aperture is disposed in the bottom wall. A funnel is supported by a funnel support disposed between the funnel and the bottom wall, the funnel guiding the contents of the enclosure to the aperture in the bottom wall. A slide valve controls the dispensing of the contents through the aperture, the slide valve being accessed through an access opening in the front side wall.

### BACKGROUND

Plastic and other non-disposable hopper bottom containers are known for transporting, storing, and dispensing contents including powders, pellets, granular material, and other relatively small items. Containers currently on the market are commonly made from high density polyethylene or other similar material. Hopper containers can have a capacity of as much as 3,000 lbs., and may have sides as long as or longer than about 48″ and a height as high as or higher than about 50″. These hopper containers are typically mounted on, or incorporate, pallets so that they can be readily moved by a forklift, and the containers are often stackable in heights of up to three or four containers. Typically, a dispensing valve is provided at the bottom of the container, at the outlet of the hopper, to dispense the container contents.

After the contents of a non-disposable container have been dispensed, an end user is left with an empty container that must be returned to the distributor or disposed of at a significant cost, which is essentially the cost of the container. Therefore, the need exists for a rugged disposable container having a contents capacity equal to that of the non-disposable containers that can be easily crushed or collapsed and disposed of at minimal cost.

### SUMMARY

In one embodiment, a disposable corrugated board dispensing container is provided. The container includes an enclosure having a bottom wall and side walls including a front side wall for containing contents therein. The bottom wall is formed by overlapping flaps attached to each of the side walls at a fold line, and an aperture is disposed in the bottom wall. A funnel is supported by a funnel support disposed between the funnel and the bottom wall, the funnel guiding the contents of the enclosure to the aperture in the bottom wall. A slide valve controls the dispensing of the contents through the aperture, the slide valve being accessed through an access opening in the front side wall.

In another embodiment, a disposable, stackable corrugated board dispensing container is provided. The container includes an enclosure panel scored and folded to form a generally rectangular enclosure having side walls and a bottom wall for containing contents therein, one of the side walls being a front side wall. The bottom wall is formed by overlapping flaps attached to each of the side walls at a fold line and has an aperture for dispensing the contents. A funnel panel is scored and folded to form a generally rectangular funnel having an outlet corresponding to the aperture in the bottom wall of the enclosure and upper edges abutting the side walls of the enclosure. A funnel support is formed by interlocking panel segments. The funnel support structure rests on the bottom wall and enables the funnel to bear the weight of the contents in the enclosure. A slide valve controls the dispensing of the contents through the aperture in the bottom wall, the slide valve being mounted between the bottom wall and the funnel support. The slide valve includes a sleeve panel scored and folded to form a sleeve having an opening aligned with the aperture in the bottom wall and a slide gate slidably received within the sleeve for selectively blocking or unblocking some or all of the opening in the sleeve. The slide valve is actuated through an opening in the front side wall. A tamper-evident tab may be formed in the front side wall and is at least partially removed to reveal the access opening. Rigid corner posts are disposed in each corner of the enclosure at the junction of adjacent side walls to provide structural support for the container and to prevent the contents from being trapped in the corners of the enclosure. Locking tabs fold downward from the bottom wall to prevent the container from sliding when mounted on a pallet. The board is coated so as to be weather-resistant.

In another embodiment, a disposable, stackable corrugated board dispensing container is provided. The container includes a generally rectangular enclosure having side walls and a bottom wall for containing contents therein, one of the side walls being a front side wall. The bottom wall has an aperture for dispensing the contents and is formed by overlapping flaps attached to each of the side walls at a fold line. A generally rectangular funnel has an outlet corresponding to the aperture in the bottom wall of the enclosure and upper edges abutting the side walls of the enclosure. A funnel support rests on the bottom wall and enables the funnel to bear the weight of the contents in the enclosure. A slide valve controls the dispensing of the contents through the aperture in the bottom wall, the slide valve being mounted between the bottom wall and the funnel support. The slide valve includes a sleeve having an opening aligned with the aperture in the bottom wall and a slide gate slidably received within the sleeve for selectively blocking or unblocking some or all of the opening in the sleeve, the slide valve being actuated through an access opening in a lower portion of the front side wall. A tamper-evident tab may be formed in front side wall and at least partially removed to reveal the access opening. Rigid corner posts are disposed in each corner of the enclosure at the junction of adjacent side walls to provide structural support for the container and to prevent the contents from being trapped in the corners of the enclosure. Locking tabs fold downward from the bottom wall to prevent the container from sliding when mounted on a pallet. The board is coated so as to be weather-resistant.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a perspective view of a dispensing container showing a cover removed from a dispensing box.

FIG. 2 is an exploded view of the dispensing box of FIG. 1.

FIG. 3 is a top view of the dispensing box of FIG. 1 without the cover.

FIG. 4A is a perspective view of one support structure and dispensing valve for mounting within a dispensing box.

FIG. 4B is a perspective view of another support structure for mounting within the dispensing box.

FIG. 5 is a plan view of a pattern for forming an outer wall of the dispensing box.

FIG. 6 is a plan view of a pattern for forming a funnel of the dispensing box.

FIG. 7 is a plan view of a pattern for forming a slide gate of the dispensing valve.

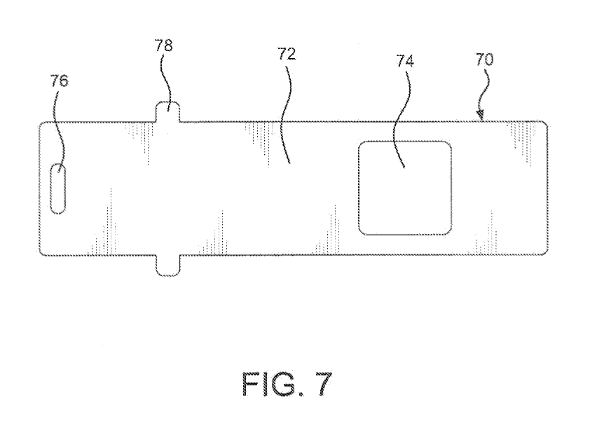

FIG. 8 is a plan view of a pattern for forming a sleeve of the dispensing valve.

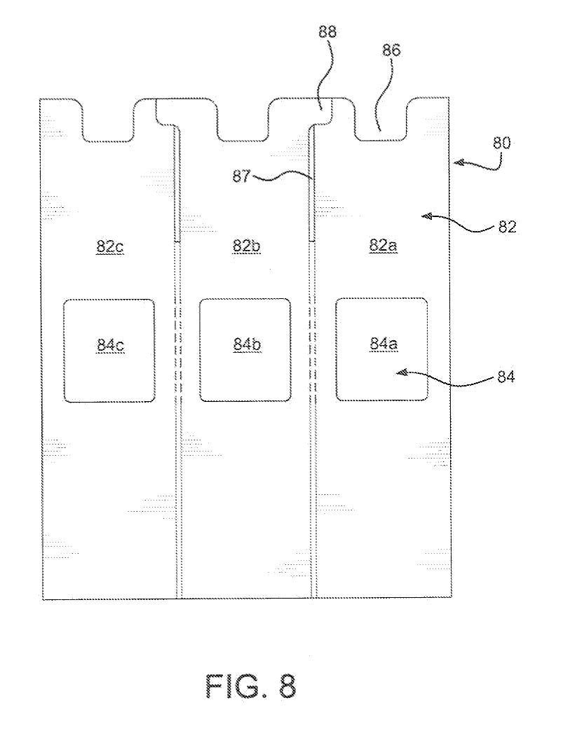

### DETAILED DESCRIPTION OF THE DRAWINGS

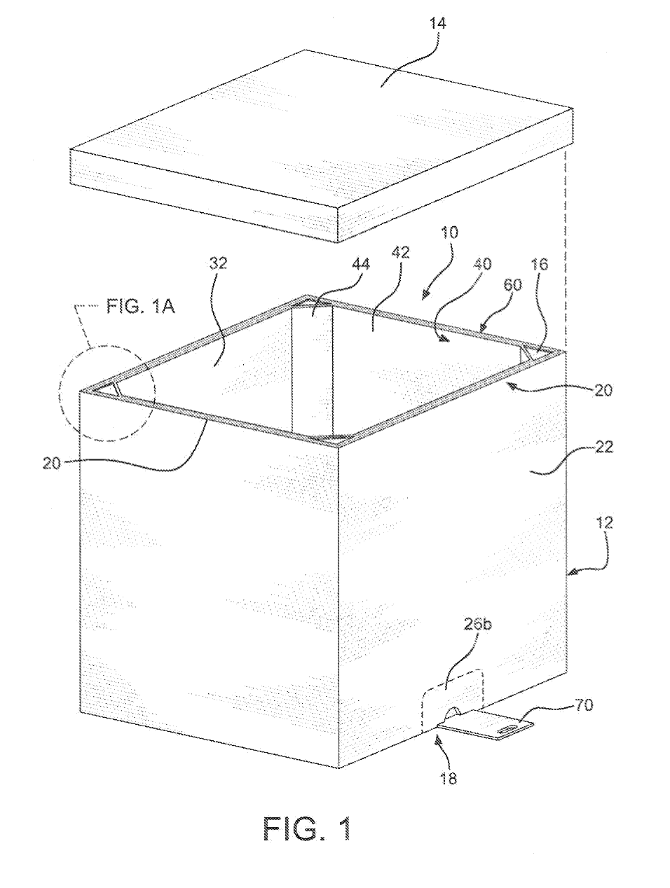

One preferred embodiment of a dispensing container 10 is shown in FIGS. 1-3 for dispensing container contents such as particulate, granular, or pelletized material. The dispensing container 10 includes a dispensing box 12 having an open top 32 and a cover 14 for enclosing the open top 32 of the box 12. The box 12 includes an outer wall 20, an inner wall 40, a funnel 50, and a funnel support 90. The dispensing box 12 also includes a bottom dispensing valve 18 for dispensing the container contents from the bottom of the container 10 under the force of gravity, as guided by the funnel 50. The box 12 may include a middle wall 60 to provide additional strength to enable the box 12 to hold a large quantity (and thus a large weight) of container contents.

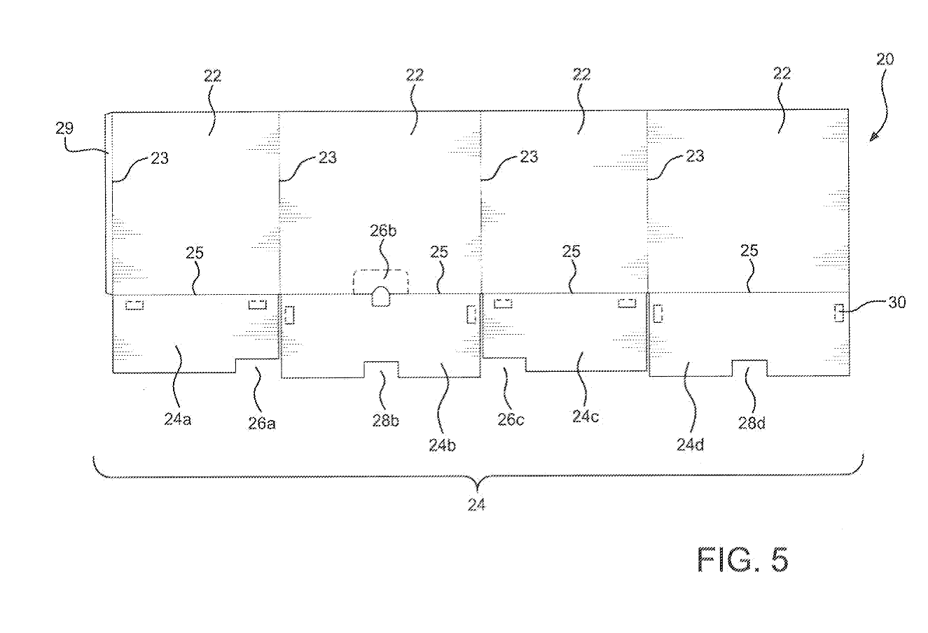

A panel pattern for forming a generally rectangular embodiment of an outer wall 20 of the box 12 having four sides according to one preferred embodiment is shown in FIG. 5. The outer wall 20 includes four side wall panels 22 and a securing panel 29, each separated from one or more adjacent panels by a fold line 23. When each fold line 23 is folded at about 90 degrees in the same direction, the securing pane 29 is secured to the farthermost side wall panel 22 using any conventional fastening device, such as adhesive or staples, and the outer wall 20 is formed.

Connected to each side wall panel 22 by another fold line 25 is a bottom flap 24. Each bottom flap 24 is somewhat different, and therefore the bottom flaps 24 are designated as a left bottom flap 24a, a front bottom flap 24b, a right bottom flap 24c, and a rear bottom flap 24d, respectively, where the front is designated as the side from which the dispensing valve 18 is actuated. (Similarly, the side wall panels 22 can be designated as 22a, 22b, 22c, and 22d corresponding to the left, front, right, and rear side walls 22, respectively.) When folded over their respective fold lines 25, the bottom flaps 24a, 24b, 24c, and 24d form an aperture 28 preferably substantially centrally disposed in the bottom of the box 12 through which the container contents can be dispensed.

The aperture 28 is bounded by notches 28b and 28d formed in the bottom flaps 24b and 24d, respectively; the bottom flaps 24a and 24c do not need to extend far enough to reach the aperture 28 and so do not need any notches. The front side wall 22b preferably includes a tamper-evident tab 26b that is at least partially separable from the front side wall 22b at perforations along some or all of the edges of the tamper-evident tab 26b. The tamper-evident tab 26b must be at least partially removed from the front side wall 22b to reveal an access opening through which a user can grasp and actuate the dispensing valve 18. In one embodiment, the tamper-evident tab 26b is completely removed by detaching the tab 26b from the front wall 22b along the perforations. In another embodiment, the tamper-evident tab 26b is not perforated entirely around its perimeter, so it can be partially detached and folded with respect to the front wall 22b.

Each of the bottom flaps 24 also preferably includes one or more locking tabs 30 that fold downward from the closed bottom flaps 24 to engage a pallet on which the box 12 is supported, to prevent the container 10 from sliding with respect to the pallet. The fully assembled outer wall 20 has four wall panels 22, a bottom formed by the overlapping bottom flaps 24a, 24b, 24c, 24d with a centrally disposed aperture 28 through which container contents can be dispensed, and an open top 32 through which container contents can be loaded.

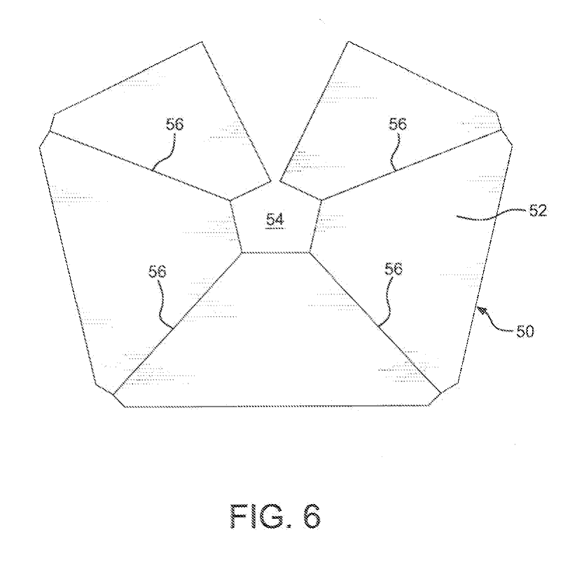

To direct the container contents toward the aperture 28 in the bottom of the outer wall 20, the funnel 50 is disposed within a lower portion of the box 12. In one preferred embodiment shown in FIG. 6, the funnel 50 can be formed from a panel pattern having five panels 52 separated by fold lines 56 and surrounding a funnel outlet 54, such that when the two outermost panels 52 are overlapped and the funnel 50 is folded at a shallow angle about each of the fold lines 56, a generally rectangular funnel 50 is formed having outer dimensions that fit within the box 12, such that the outlet 54 in the funnel 50 is aligned with the aperture 28 in the bottom of the outer wall 20.

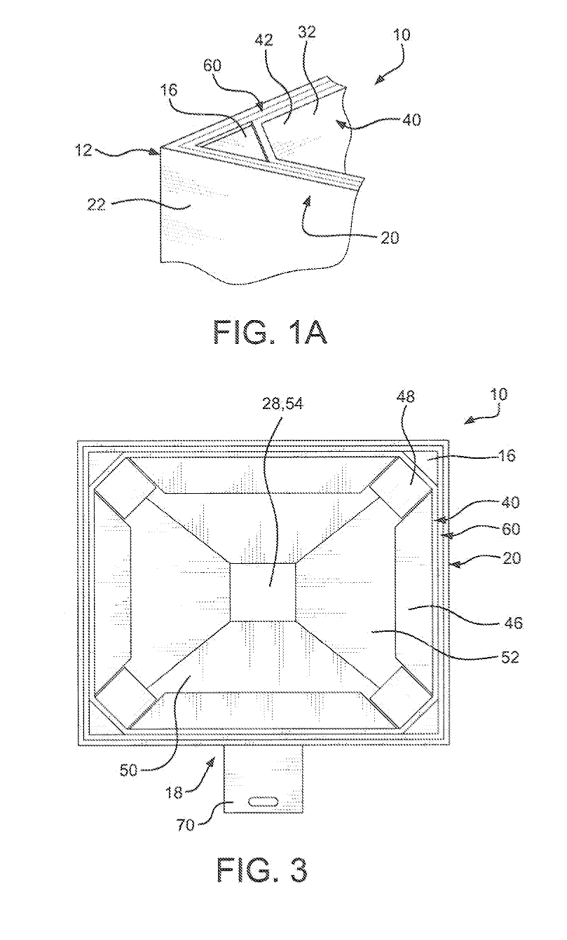

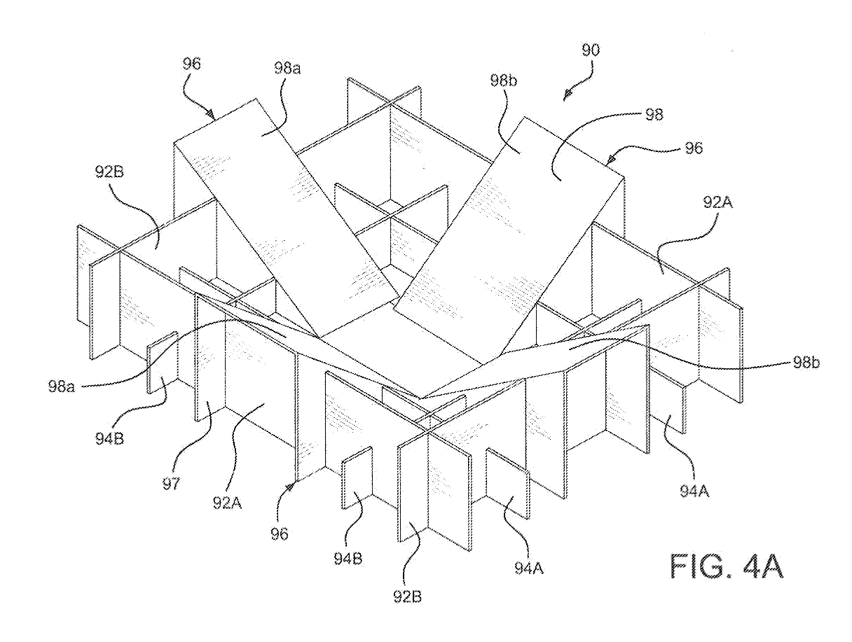

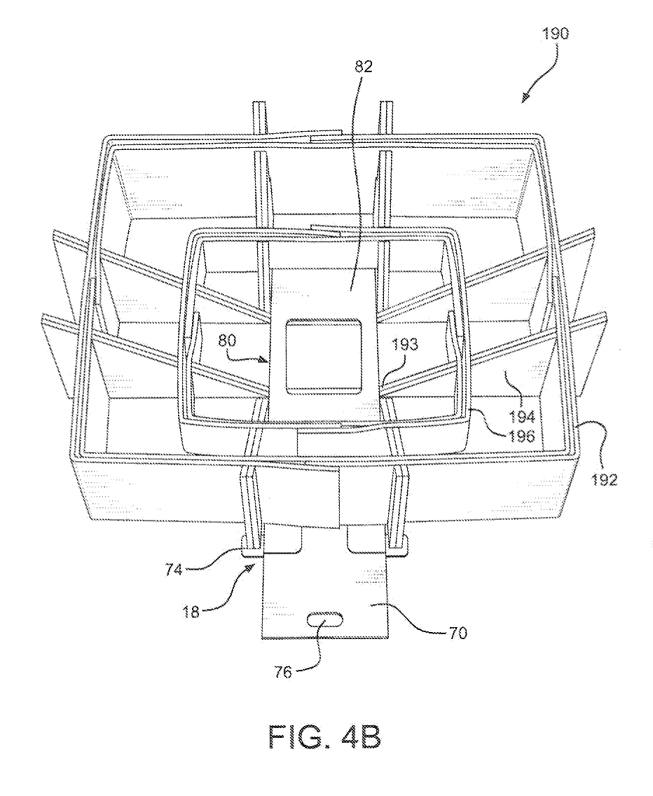

The funnel 50 is supported against the weight of the container contents by a funnel support 90. One embodiment of a funnel support 90 is shown in FIGS. 2 and 4A, and another embodiment of a funnel support 190 is shown in FIG. 4B.

The funnel support 90 of FIGS. 2 and 4A includes four ramped support members 96 each including a ramp surface 98 supported by a substantially triangular leg 97 on each side. The legs 97 attached at fold lines to the ramp surface 98. In one embodiment, the legs 97 are formed from a double ply of material folded over itself. The ramped support members 96 are held in position by nested rectangles formed by interlocking support members, including two pairs of outer support members 92A, 92B and two pairs of inner support members 94A, 94B. The slopes of the ramp surfaces 98 are preferably designed to have a slope that matches the desired slope of the funnel. If the container is square, the slopes of the surfaces 98 would all be the same. If the container is rectangular, the slopes of the ramped surfaces opposite from each other (e.g., 98a) would be the same but the slopes of adjacent ramped surfaces would be different (i.e., ramp 98a is different that ramp 98b). In one preferred embodiment, the slope of the ramp surface 98 is about 34.7 degrees in one direction (i.e., two opposed sides) and about 39.2 degrees in the perpendicular direction (i.e., two other opposed sides).

The alternative funnel support 190 of FIG. 4B preferably includes an outer frame 192 and an inner frame 196 joined by tapered cross members 194. The outer frame 192 is generally rectangular, and the inner frame 196 is generally rectangular and has shorter sides than the corresponding sides of the outer frame 192. The inner frame 196 also has a height that is proportionally smaller than the height of the outer frame 192 so as to define a slope for the funnel. In the illustrated embodiment, the outer frame 192 and inner frame 196 are each made from two overlapping pieces of corrugated material. One of the overlapping pieces has a slightly shorter height than the other so that the height of each frame tapers from outside toward the inside of the frame. The tapered cross members 194 taper from a zero height toward the center of the funnel support 190 to a height that is preferably larger than that of the outer frame 192 at a location farther from the center of the funnel support 190 than the outer frame 192. The height of the tapered cross members 194 matches those of the outer frame 192 and the inner frame 196 wherein the cross members 194 adjoin those frames 192 and 196. As shown, eight cross members 194 are provided, two on each side of the support frames 192 and 196. Tips 193 of the cross members 194 bound a generally rectangular open region that is somewhat larger than the aperture 28 in the bottom of the outer wall 20 and the outlet 54 in the funnel 50.

In one embodiment, the taper of the cross members 194 is between about 20 degrees and about 60 degrees from parallel to the bottom of the box 12 to allow for free and controllable flow of the container contents. In another embodiment, the taper of the cross members 94 is between about 30 degrees and about 45 degrees from parallel to the bottom of the box 12.

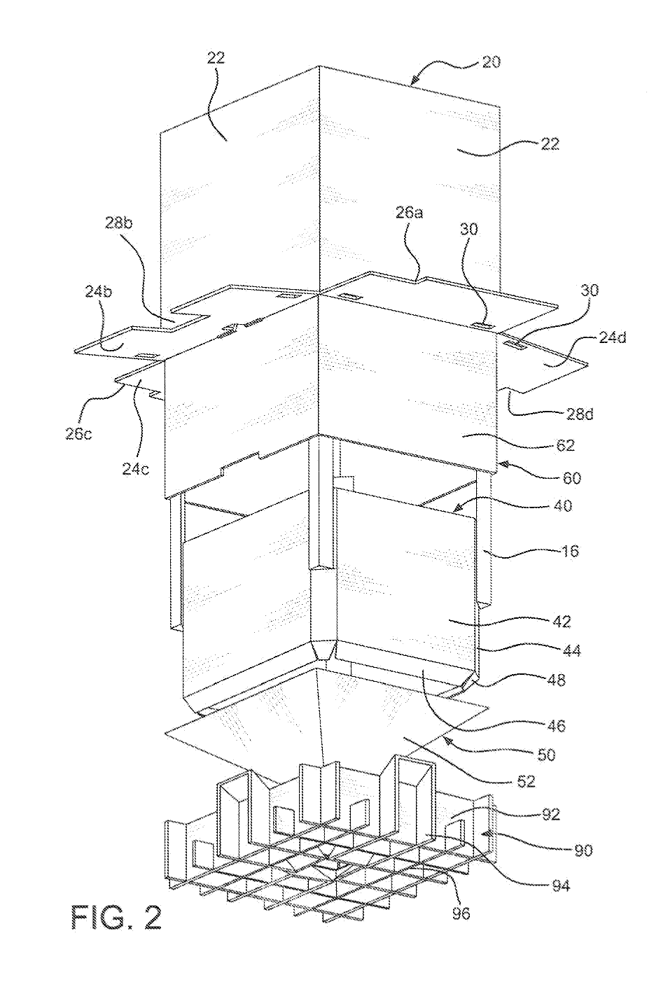

The inner wall 40 helps to direct the container contents to the funnel 50, to provide structural support for the outer wall 20, and to maximize the amount of container contents that can be dispensed through the aperture 28. As depicted in FIGS. 2 and 3, the inner wall 40 preferably has a generally octagonal shape, including eight panels, four longer inner wall panels 42 alternating with four shorter inner corner panels 44. The middle wall 60 and the outer wall 20 each preferably have a generally rectangular shape. The middle wall 60 includes four panels 62 with two opposed panels in one direction being slightly longer than two opposed panels in the perpendicular direction. Each corner panel 44 of the inner wall 40 is supported by a generally triangular corner post 16 that is disposed in each corner of the box 12 at the junction of adjacent middle wall panels 62. The corner posts 16 are located between the inner wall 40 and the middle wall 60 and are thus separated from the container contents. The corner posts 16 also provide structural rigidity to the box 12 in the vertical direction to allow multiple containers 10 to, be stacked on top of one another.

Each inner wall panel 42 preferably has a lower flap 46 that is folded inwardly toward the center of the box 12, and each inner corner panel 44 preferably has a lower flap 48 that is folded inwardly toward the center of the box 12, so that when the inner wall 40 is placed inside the box 12, the lower flaps 46 and 48 overlap with and rest on top of an upper portion of the panels 52 of the funnel 50. Consequently, as the container contents flow from the aperture 28 and the level of container contents in the box 12 decreases, the corner panels 44 keep container contents from becoming trapped in the corners of the box 12 and the flaps 46 and 48 guide the container contents smoothly into the funnel 50.

The dispensing valve 18 is designed so that it can be opened and closed when the box 12 is full, as well as when the box 12 is empty. The dispensing valve 18 preferably includes a slide gate 70 which is slidably mounted to slide back and forth within a sleeve 80. The sleeve 80 includes three panels 82a, 82b, 82c each having an opening 84a, 84b, 84, respectively, that is aligned with the aperture 28 in the bottom of the outer wall 20 when the dispensing valve 18 is mounted to the box 12. The panels 82a, 82b, 82c are separated by fold lines 87 such that when panels 82a, 82b, and 82c are folded over onto each other, a pocket is made for receiving, the slide gate 70. The central panel 82b includes side tabs 88 for securing the sleeve 80 within the box 12. When installed the sleeve 80 is located between the bottom flaps 24 of the outer wall 20 and the funnel support 90, as can be understood from FIGS. 1 and 4, with the tabs 88 located within the box 12. Once the tamper-evident tab 26b is detached or folded away, the slide gate 70 can be grasped for sliding in and out of the sleeve 80.

The slide gate 70 includes a panel 72 with an opening 74, as well as a gripping notch 76 and stop tabs 78. When the slide gate 70 is disposed within the sleeve 80, the slide gate 70 can slide back and forth, inwardly and outwardly from an open end of the sleeve 80. When the slide gate 70 is fully inserted into the sleeve 80, the panel 72 blocks the opening 84 in the sleeve 80, and thus prevents any of the container contents from being dispensed from the box 12. By grasping the panel 72 at the gripping notch 76, the panel 72 can be slid outward from the box 12 until the opening 74 is partially or fully aligned with the opening 84 in the sleeve 80, enabling container contents to be dispensed.

The stop tabs 78 locate the position at which the dispensing valve 18 is fully open and also prevent the panel 72 from being accidentally withdrawn completely from the sleeve 80. When the slide gate panel 72 is fully opened, so that openings 74 and 84 are fully aligned, the stop, tabs 78 contact an inner portion of the front wall panel 22b adjacent to the access opening. Because movement of the slide gate 70 within the sleeve 80 is perpendicular to the flow of the container contents from the box 12 through the aperture 28, the slide gate 70 can be readily opened and closed while the box 12 is full, as well as when the box 12 is empty. The panel 72 extends beyond the opening 74 so that the panel 72 is fully supported on all sides of the opening 74 by the sleeve 80 even when the openings 74 and 84 are substantially aligned. When the slide gate 70 is closed and the panel 72 blocks the hole 84 in the sleeve, the slide gate panel 72 is sufficiently strong to support the weight of the container contents in the box 12 when the box 12 is full.

In one embodiment, all of the components of the container 10 are made from corrugated board, except for the corner posts 16 which may be made from wood or other structural material. In one embodiment, some or all the surfaces of the boards are coated with a water-resistant coating in the form of a container wax, to protect the container contents and to prevent softening of the container 10 when exposed to moisture. The container was can be any one of various commercially available petroleum based wax products, including but not limited to those sold under the trade names of Nocheck®, Parafflex®, and Astorlite®.

In another embodiment, as an alternative to coating some or all of the board surfaces with a water-resistant coating, a disposable bag 200 may be situated inside the inner wall 40 to hold the material to be dispensed. The bag 200 is preferably made from paper and coated with a water-resistant coating and is sufficiently flexible to mold to the inner contours of the inner wall 40 and funnel 50 when the paper bag 200 is filled with pelletized or granular material to be dispensed. The bag 200 preferably includes a hole located near the funnel so as permit the material to flow out through the slide valve. Alternatively, the bag may be made from a material, such as plastic, which is generally water-resistant. The bag 200 also preferably has sufficient length so as to extend beyond the top end of the box 12 such that an upper portion of the bag 200 can be folded over along the outside of the outer wall 20, thereby generally protecting the outside of the container from the elements, such as rain.

The sides of the box 12 comprise either two or three layers of corrugated board, including the outer side walls 22, the inner side walls 42 and corners 44, and optional middle side walls 62. The bottom of the box 12 comprises the overlapping bottom flaps 24a, 24b, 24c, and 24d, on which rests the funnel support 90 and the funnel 50. The lower flaps 46 and 48 of the inner side walls 42 and corners 44 overlap an upper portion of the funnel 50. The corner posts 16, disposed between the middle wall 60 and the inner wall 40 provide vertical support for the box 12, and the cover 14 can enclose the open top 34 of the box 12. The dispensing valve 18 is located between the bottom of the outer wall 20 and the funnel support 90. The slide gate 70 can be moved inward and outward with respect to the box 12 within the sleeve 80 to selectively allow the container contents to flow, or block the container contents from flowing, through the aperture 28 in the bottom of the box 12. Since the container is fabricated almost entirely from corrugated board, it is relatively lightweight when empty. When the container contents have been fully dispensed, the entire container 10 can be reused or disposed of, with or without being crushed, either for recycling or for non-recycled disposal.

While the preferred embodiment illustrated in the figures includes the dispensing aperture in the center of the bottom wall, it is also contemplated that the dispensing aperture can be located near and edge of the bottom wall or in the side wall near the bottom. the funnel, slide valve, and the frame would be fabricated so as to properly direct the flow of the contents to the opening. Based on the teachings provided above, a person skilled in the art would be readily capable of modifying the construction of the container to accomplish such dispensing.

The foregoing describes the invention in terms of embodiments foreseen by the inventors for which an enabling description was available, notwithstanding that insubstantial modifications of the invention, not presently foreseen, may nonetheless represent equivalents thereto.

1. A disposable corrugated board dispensing container having a top and a bottom, the container comprising:
an enclosure having a bottom wall and side walls including a front side wall for containing contents therein, the bottom wall being formed by overlapping flaps attached to each of the side walls at a fold line;
an aperture formed in one of the walls, at or near the bottom;
a funnel supported by a funnel support disposed between the funnel and the bottom wall, the funnel guiding the contents of the enclosure to the aperture in the wall; and
a slide valve for controlling the dispensing of the contents through the aperture, the slide valve being accessed through an access opening in one of the side walls.

2. The container of claim 1, wherein the aperture is formed in the bottom wall and wherein the enclosure, funnel and slide valve are formed from corrugated board.

3. The container of claim 1, further comprising a tamper-evident tab that must be at least partially removed from the opening in the front side wall to permit access to the slide valve.

4. The container of claim 1, further comprising one or more locking tabs folded downward from the bottom wall to prevent the container from sliding when mounted on a pallet.

5. The container of claim 1 further comprising rigid posts disposed in each corner of the enclosure at the junction of adjacent side walls, the posts providing structural strength to enable one or more like containers to be stacked on top of the container, the posts preventing the contents from being trapped in corners of the enclosure.

6. The container of claim 1, wherein at least some of the boards are coated with container wax so as to be at least partially weather resistant.

7. The container of claim 1, the enclosure having an open top, the container further comprising a removable cover for removably closing the open top.

8. The container of claim 1, wherein the slide valve is disposed between the bottom wall of the container and the funnel support, the slide valve including a slide gate slidably received into a sleeve such that the slide gate can selectively block or unblock some or all of an opening in the sleeve that is aligned with the aperture in the bottom wall.

9. The container of claim 7, the slide gate having an opening therein with a size and shape substantially the same as the opening in the sleeve, the slide gate having stop tabs to locate a position at which the respective slide gate and sleeve openings are aligned, wherein the slide gate is supported on all sides of the opening by the sleeve when the respective slide gate and sleeve openings are substantially aligned.

10. The container of claim 1, further comprising an inner wall fitting within the enclosure, the inner wall having longer inner side walls disposed adjacent to the enclosure side walls and shorter inner side walls disposed adjacent to the posts, each inner side wall having an inner bottom flap folded inward to overlap the funnel to direct the container contents into the funnel.

11. The container of claim 10, further comprising a middle wall panel having side walls disposed between the enclosure side walls and the inner side walls, the middle panel made from corrugated board.

12. The container of claim 1, further comprising a bag located within the container, the bag being coated with a water-resistant coating or made from material that is substantially water-resistant.

13. A disposable, stackable corrugated board dispensing container comprising:
a corrugated board enclosure panel scored and folded to form a generally rectangular enclosure having side walls and a bottom wall for containing contents therein, one of the side walls being a front side wall, the bottom wall being formed by overlapping flaps attached to each of the side walls at a fold line, the bottom wall having an aperture for dispensing the contents;
a corrugated board funnel panel scored and folded to form a generally rectangular funnel having an outlet corresponding to the aperture in the bottom wall of the enclosure and upper edges abutting the side walls of the enclosure;
a corrugated board funnel support resting on the bottom wall and enabling the funnel to bear the weight of the contents in the enclosure;
a slide valve for controlling the dispensing of the contents through the aperture in the bottom wall, the slide valve being mounted between the bottom wall and the funnel support, the slide valve including sleeve panel scored and folded to form a sleeve having an opening aligned with the aperture in the bottom wall and a slide gate slidably received within the sleeve for selectively blocking or unblocking some, or all of the opening in the sleeve, the slide valve being actuated through an access opening in the front side wall;
rigid corner posts disposed in each corner of the enclosure at the junction of adjacent side walls to provide structural support for the container and to prevent the contents from being trapped in corners of the enclosure; and
locking tabs folding downward from the bottom wall to prevent the container from sliding when mounted on a pallet;
wherein at least part of the board is coated so, as to, be at least partially weather-resistant.

14. The container of claim 13, further comprising an inner corrugated board panel scored and folded to form a generally octagonal inner wall fitting within the enclosure, the inner wall having longer inner side walls disposed adjacent to the enclosure side walls and shorter inner side walls disposed adjacent to the corner posts, each inner side wall having an inner bottom flap folded inward to overlap the funnel to direct the container contents into the funnel.

15. The container of claim 14, further comprising a middle wall corrugated board panel scored and folded to form a generally rectangular middle wall having side walls disposed between the enclosure side walls and the inner side walls.

16. The container of claim 13, the slide gate having an opening therein with a size and shape substantially the same as the opening in the sleeve, the slide gate having stop tabs to locate a position at which the respective slide gate and sleeve openings are aligned, wherein the slide gate is supported on all sides of the opening by the sleeve when the respective slide gate and sleeve openings are substantially aligned.

17. A disposable, stackable corrugated board dispensing container comprising:
a generally rectangular corrugated board, enclosure having side walls and a bottom wall for containing contents therein, one of the side walls being a front side wall, the bottom wall having an aperture for dispensing the contents, the bottom wall being formed by overlapping flaps attached to each of the side walls at a fold line;
a generally rectangular corrugated board funnel having an outlet corresponding to the aperture in the bottom wall of the enclosure and upper edges abutting the side walls of the enclosure;
a corrugated board funnel support resting on the bottom wall and enabling the funnel to bear the weight of the contents in the enclosure;
a slide valve for controlling the dispensing of the contents through the aperture in the bottom wall, the slide valve being mounted between the bottom wall and the funnel support, the slide valve including a sleeve having an opening aligned with the aperture in the bottom wall and a slide gate slidably received within the sleeve for selectively blocking or unblocking some or all of the opening in the sleeve, the slide valve being actuated through an access opening in the front side wall;
a tamper-evident tab in the front side wall such that the tamper-evident tab must be at least partially removed to reveal the access opening;
rigid corner posts disposed in each corner of the enclosure at the junction of adjacent side walls to provide structural support for the container and to prevent the contents from being trapped in corners of the enclosure; and
locking tabs folding downward from the bottom wall to prevent the container from sliding when mounted on a pallet;
wherein at least part of the board is coated so as to be at least partially weather-resistant.

18. The container of claim 17, further comprising a generally octagonal corrugated board inner wall fitting within the enclosure, the inner wall having longer inner side walls disposed adjacent to the enclosure side walls and shorter inner side walls disposed adjacent to the corner posts, each side wall having an inner bottom flap folded inward to overlap the funnel to direct the container contents into the funnel.

19. The container of claim 18, further comprising a generally rectangular corrugated board middle wall having side walls disposed between the enclosure side walls and the inner side walls.

20. The container of claim 17, the slide gate having an opening therein with a size and shape substantially the same as the opening in the sleeve, the slide gate having stop tabs to locate a position at which the respective slide gate and sleeve openings are aligned, wherein the slide gate is supported on all sides of the opening by the sleeve when the respective slide gate and sleeve openings are substantially aligned.

21. The container of claim 17, the enclosure having an open top, the container further comprising a removable cover for removably closing the open top.
